(19) United States
(12) Patent Application Publication
(10) Pub. No.: US 2023/0162336 A1
(43) Pub. Date: May 25, 2023

(54) METHOD OF OPERATING FAST FOURIER TRANSFORM FOR HOLOGRAM GENERATION AND DEVICE USING THE SAME

(71) Applicant: ELECTRONICS AND TELECOMMUNICATIONS RESEARCH INSTITUTE, Daejeon (KR)

(72) Inventors: Jae Hong LEE, Daejeon (KR); Ho Min KANG, Daejeon (KR); Duk Su KIM, Daejeon (KR)

(73) Assignee: ELECTRONICS AND TELECOMMUNICATIONS RESEARCH INSTITUTE, Daejeon (KR)

(21) Appl. No.: 17/993,123

(22) Filed: Nov. 23, 2022

(30) Foreign Application Priority Data
Nov. 24, 2021 (KR) 10-2021-0163447

(51) Int. Cl. G06T 5/10; G06T 1/60; G06T 1/20; G03H 1/16; G03H 1/04

(52) U.S. Cl. CPC G06T 5/10; G06T 1/60; G06T 1/20; G03H 1/16; G03H 1/0443; G06T 2207/20056; G03H 2226/02

(57) ABSTRACT

Disclosed herein a method of operating fast fourier transform for hologram generation and device using the same. The method includes: performing, by a first processor of an image processing device, shift-transposition that executes, for image data arranged in a matrix form, a shift operation and a matrix transposition operation for a position change simultaneously; performing, by a second processor that has faster operation performance than the first processor and processes an image, primary 1D FFT for the shift-transposed image data; performing, by the first processor, a matrix transposition operation for the primary 1D FFT-processed image data; and performing, by the second processor, secondary 1D FFT for the matrix transposition-operated image data.

### CROSS REFERENCE TO RELATED APPLICATION

The present application claims priority to a Korean patent application No. 10-2021-0163447, filed Nov. 24, 2021, the entire contents of which are incorporated herein for all purposes by this reference.

### BACKGROUND OF THE INVENTION

### Field of the Invention

The present disclosure relates to a method for operating fast Fourier transform for hologram generation and an image processing device using the method, and more particularly, to a method for operating fast Fourier transform for hologram generation, which reduces a computational throughput and time, and an image processing device using the method.

### Description of the Related Art

Recently, the 3D image-related technology is being widely studied. Active studies are being conducted for a device of realizing a high-quality hologram in real time by using a complex spatial light modulator (SLM) capable of controlling both the amplitude and phase of light.

A computer generated hologram (CGH) is recently used to play a hologram image, and an image processing device calculates a hologram value for each position on a hologram plane, which is accompanied by a massive operation amount. In other words, to represent a single point in a space, an image processing device needs to perform a Fourier transform, and as many Fourier transforms as the number of image datasets should be performed to represent an image in a space.

Image processing devices like TV and mobile device can process image data to play a hologram image. In this case, an image processing device may perform a Fourier transform for image data and play an image by using the transformed data.

When an image processing device performs a Fourier transform, a large operation amount and a lot of time are required. Especially, portable devices like mobile devices have limitations in available power as well as in size. Accordingly, when performing Fourier transform, there is a need for methods of reducing an operation amount and time.

### SUMMARY

A technical object of the present disclosure is to provide a method for operating fast Fourier transform for hologram generation, which reduces a computational throughput and time, and an image processing device using the method.

The technical objects of the present disclosure are not limited to the above-mentioned technical objects, and other technical objects that are not mentioned will be clearly understood by those skilled in the art through the following descriptions.

According to the present disclosure, there is provided a method of operating fast fourier transform for hologram generation, the method comprising: performing, by a first processor of an image processing device, shift-transposition that executes, for image data arranged in a matrix form, a shift operation and a matrix transposition operation for a position change simultaneously; performing, by a second processor that has faster operation performance than the first processor and processes an image, primary 1D FFT for the shift-transposed image data; performing, by the first processor, a matrix transposition operation for the primary 1D FFT-processed image data; and performing, by the second processor, secondary 1D FFT for the matrix transposition-operated image data.

According to the embodiment of the present disclosure in the method, the image data may be data of a block that is set in a predetermined data amount by considering resource performance of the second processor.

According to the embodiment of the present disclosure in the method, the method may further comprise setting, by the first processor, the data amount of the block based on overall image data with the matrix form and a memory size of the second processor before the performing of the shift-transposition.

According to the embodiment of the present disclosure in the method, the setting of the data amount of the block may determine the data amount based on a number of streams used by the second processor and a data size of a line transmitted to the second processor together with the memory size of the second processor.

According to the embodiment of the present disclosure in the method, the block may be generated in a multiple number and the first processor includes a plurality of threads and allocates the threads to each of the block, and the performing of the shift-transposition and the performing of the matrix transposition operation may be implemented in a thread allocated to each block.

According to the embodiment of the present disclosure in the method, the method may further comprise transmitting the shift-transposed block to the second processor, after the performing of the shift-transposition, transmitting the primary 1D FFT-processed block to the first processor, after the performing of the primary 1D FFT, and transmitting the matrix transposition-operated block to the second processor, after the performing of the matrix transposition operation. At least one of processes associated with the shift-transposition for another block, the primary and secondary 1D FTTs for another block, the matrix transposition operation for another block, and transmission for another block may be performed on a thread different from the thread of the block in parallel processing during the transmitting to the first processor or the second processor.

According to the embodiment of the present disclosure in the method, the transmitting to the first processor or the second processor may be performed for the parallel processing asynchronously with at least one of at least one of processes associated with the shift-transposition for another block, the primary and secondary 1D FTTs for another block, the matrix transposition operation for another block, and transmission for another block.

According to the embodiment of the present disclosure in the method, the second processor may be further configured to have a plurality of streams in a core, the primary and secondary 1D FTTs may be performed in the streams corresponding to the allocated thread, and the transmitting to the first processor or the second processor may transmit to the first processor or the second processor by copying the block into a pinned memory buffer that is allocated to each of the streams.

According to the embodiment of the present disclosure in the method, the second processor may have a smaller memory size than the first processor.

According to the embodiment of the present disclosure in the method, the first processor may be a central processing unit (CPU), and the second processor may be a graphic processing unit (GPU).

According to another embodiment of the present disclosure, there is provided an image processing device for operating a fast Fourier transform for hologram generation, the device comprising: a first processor configured to perform overall control over the image processing device; and a second processor that has faster operation performance than the first processor and processes an image. The first processor is configured to perform shift-transposition that executes, for image data arranged in a matrix form, a shift operation and a matrix transposition operation for a position change simultaneously. The second processor is configured to perform primary 1D FFT for the shift-transposed image data. The first processor is configured to perform a matrix transposition operation for the primary 1D FFT-processed image data. Also, the second processor is configured to perform second 1D FFT for the matrix transposition-operated image data.

The features briefly summarized above for this disclosure are only exemplary aspects of the detailed description of the disclosure which follow, and are not intended to limit the scope of the disclosure.

According to the present disclosure, it is possible to provide a method for operating fast Fourier transform for hologram generation, which reduces a computational throughput and time, and an image processing device using the method.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 is a block diagram for an image processing device according to an embodiment of the present disclosure.

FIG. 2 is a block diagram of a central processing unit.

FIG. 3 is a block diagram of a graphic processing unit.

FIG. 4 is a flowchart showing a method of operating fast Fourier transform according to another embodiment of the present disclosure.

FIG. 5 is a view exemplifying shift-transposition processing.

FIG. 6 is a view exemplifying parallel processing of a plurality of blocks using multiple threads and multiple streams.

FIG. 7 and FIG. 8 are tables for comparing operation processing times between a fast Fourier operation method according to the present disclosure and a conventional fast Fourier operation method.

### DETAILED DESCRIPTION OF THE INVENTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present invention and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

In the present disclosure, each of phrases such as “A or B”, “at least one of A and B”, “at least one of A or B”, “A, B or C”, “at least one of A, B and C”, “”at Each of the phrases such as “at least one of A, B or C” and “at least one of A, B, C or combination thereof” may include any one or all possible combinations of the items listed together in the corresponding one of the phrases.

Hereinafter, embodiments of the present disclosure will be described with reference to the accompanying drawings.

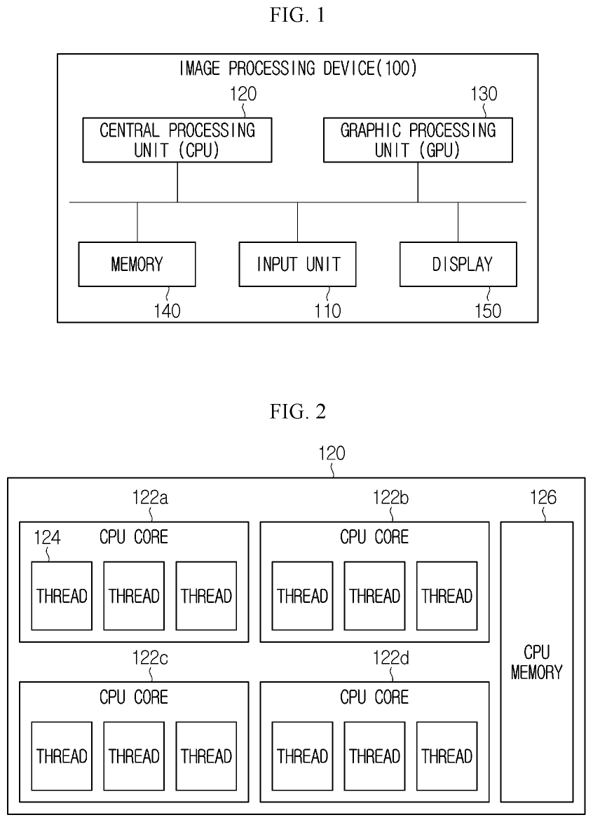

FIG. 1 is a block diagram for an image processing device according to an embodiment of the present disclosure.

An image processing device 100 is a device of generating a hologram by receiving image data consisting of a plurality of pixels and, for example, may be a device by a computer generated hologram (CGH).

The image processing device 100 may include an input unit 110, a first processor 120 for overall control of the device 100, a second processor 130 for generating an image, a memory 140 and a display 150.

The input unit 110 may receive image data in which a plurality of pixels is arranged in a matrix form. The memory 140 may be a module capable of temporarily or permanently storing data transmitted and received in the image processing device 100. In addition, as an example, the memory 140 may be provided as a pinned memory buffer that temporarily stores data transmitted between the first processor 120 and the second processor 130. As another example, at least one of memories 126 and 134 in the first and second processors 120 and 130 may be used as a pinned memory buffer.

For example, the first processor 120 may be a central processing unit (CPU) 120, and the second processor 130 may be a processor for image processing, which has faster computational performance than the first processor 120, and may be configured, for example, as a graphic processing unit (GPU) 130. Unlike the computational performance, the second processor 130 may have a smaller memory size than the first processor.

The central processing unit 120 exemplified as the first processor may be a key control device, which controls the image processing device 100 and operates a program, or be a chip embedded with the function. The central processing unit 120 may memorize an input of information received from outside and decode and operate a command of a computer program.

FIG. 2 is a block diagram of a central processing unit. As shown in FIG. 2, the central processing unit 120 may include a plurality of CPU cores 122a to 122d, which execute operation and commands to control each module, a plurality of threads 124 embedded therein, and a CPU memory 126.

The graphic processing unit 130 exemplified as a second processor may be a specialized circuit that is designed to quickly process and modify memory and accelerate image generation in a frame buffer to be output to the display 150. The graphic processing unit 130 may process computer graphics and images very effectively. The graphic processing unit 130 may realize a high-level parallel structure more efficiently than multipurpose CPUs.

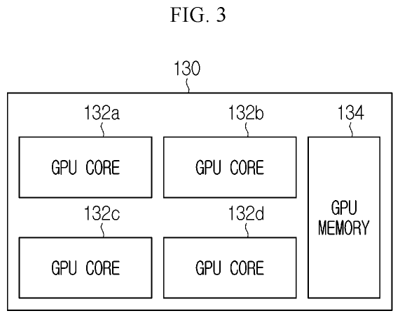

FIG. 3 is a block diagram of a graphic processing unit. The graphic processing unit 130 may include a plurality of GPU cores 132a to 132d and a GPU memory 134. The GPU cores 132a to 132d may perform a specific process by using a stream and perform a plurality of processes in parallel by allocating them to each of a plurality of streams. The GPU memory 134 may be configured as a smaller memory than the CPU memory 126, and at least one of them may be provided as a pinned memory buffer. A series of processes implemented in the thread 124 may be allocated to a single stream in the GPU cores 132a to 132d.

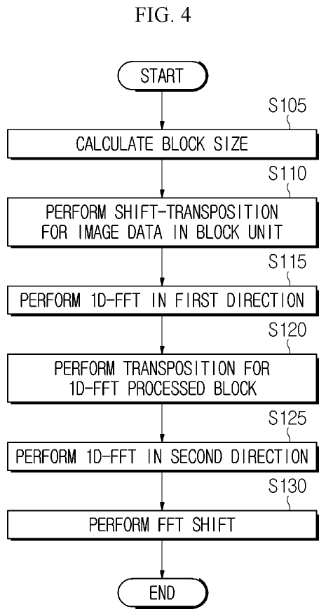

Hereinafter, a method for operating a fast Fourier transform according to the present disclosure will be described with reference to FIG. 4 to FIG. 6. The method will be described by exemplifying a method using the image processing device of FIG. 1. Furthermore, first and second processors are described as examples of the central processing unit 120 and the graphic processing unit 130, but the first and second processors are not limited thereto, if they satisfy a technical requirement according to the above description.

FIG. 4 is a flowchart showing a method of operating fast Fourier transform according to another embodiment of the present disclosure.

Based on overall image data with a matrix form received from the input unit 110 and resource performance of the graphic processing unit 130, the central processing unit 120 may set a size of an image data group, that is, a block or chunk with a predetermined data amount to be applied to a fast Fourier operation (S105). A block size may be a data amount of a block.

The resource performance of the graphic processing unit 130 may be a size of the GPU memory 134, a number of streams used by the graphic processing unit 130, and a line transmitted to the graphic processing unit 130 (e.g., a bandwidth of a bus line transmitted from the central processing unit 120 to the graphic processing unit 130).

Next, the central processing unit 120 may perform shift-transposition processing for image data in a block unit, which executes a shift operation and a matrix transposition operation for a position change at the same time (S110).

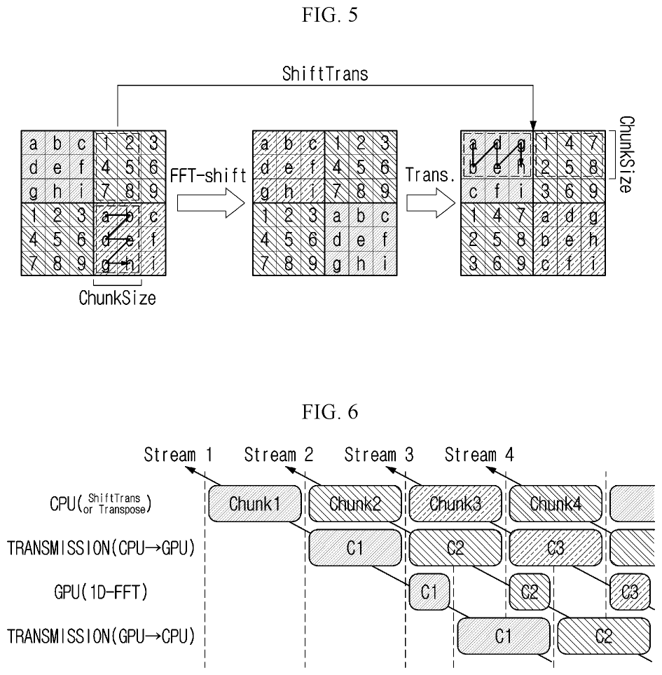

The shift-transposition processing may be executed using a single function that operates shift and matrix transposition at the same time. Such a function may be Equation 1 below. Equation 1 may be a single function generated from Equation 2 related to conventional shift processing and Equation 3 related to transposition processing. In Equation 1, x and y are positions of image data in a matrix form (data positions when a center point of a hologram plane or complex matrix is employed as an origin), and in FIG. 5, w and h may be the width and height of a hologram plane (matrix).

ShiftTrans(x, y)=(ShiftY(y), ShiftX(x)) [Equation 1]

ShiftX(x)=(x+w/2)mod w [Equation 2]

ShiftY(y)=(y+h/2)mod h [Equation 3]

Trans(x,y)=(y,x) [Equation 4]

As shown in FIG. 5, shift-transposition processing is not performed in two steps of FFT shift and matrix transposition, but as illustrated in FIG. 5, image data arranged in a matrix form may be mapped to a corresponding data position by shift-transposition processing, that is, by applying FFT shift and matrix transposition simultaneously. FIG. 5 is a view exemplifying shift-transposition processing. The conventional two-step processing utilizes a multi-thread technique of allocating a thread to each processing for parallel processing, but this causes an excessive increase of overhead for memory copy that is required for transfer to another step. According to the present disclosure, as two processings are performed simultaneously, the overhead for memory copy may be significantly reduced.

Specifically, FFT shift may be an operation of changing a position of data. Referring to FIG. 5, after overall image data is classified by a middle point of a data dimension axis, for example, a bottom right block where a Fourier operation starts, the position of the classified image data thus may be changed. By performing FFT-shift before and after a fast Fourier transform is performed, data of FFT may have a reduced offset.

Next, the central processing unit 120 may transmit a shift-transposed block to the graphic processing unit 130.

Next, the graphic processing unit 130 may perform primary 1D FFT processing for the shift-transposed image data (S115).

When describing primary ID FFT with reference to FIG. 5, the graphic processing unit 130 may perform primary 1D FFT processing in a row direction (or first direction) of a shift-transposed block, that is, a top right block of FIG. 5.

The primary 1D FFT processing may be implemented using Equation 4 below. Here, f(x, y) is a complex matrix with a size of NxN, and x and y may be a row and a column respectively.

$$\begin{matrix}F ( {O}_{x} , {O}_{y} ) = {\sum }_{x = 0}^{N - 1} {\sum }_{y = 0}^{N - 1} f ( x , y ) \times {e}^{- j 2 π ( {O}_{x} \frac{x}{N} + {O}_{y} \frac{y}{N} )} \\ = {\sum }_{x = 0}^{N - 1} [ {\sum }_{y = 0}^{N - 1} f ( x , y ) \times {e}^{- j 2 π ( {O}_{y} \frac{y}{N} )} ] \times {e}^{- j 2 π ( {O}_{x} \frac{x}{N} )} \\ = {\sum }_{x = 0}^{N - 1} {f}^{′} ( x , y ) \times {e}^{- j 2 π ( {O}_{x} \frac{x}{N} )}\end{matrix} \qquad [ Equation 4 ]$$

Next, the graphic processing unit 130 may transmit the 1D FFT-processed block to the central processing unit 120.

Next, the central processing unit 120 may perform a matrix transposition operation for the primary 1D FFT-processed block (S120).

In case the graphic processing unit 130 performs secondary ID FFT processing without the processing of step S120, the secondary 1D FFT processing is performed in a column direction of the shift-transposed block. Thus, the graphic processing unit 130 has latency in accessing image data arranged not in a row direction but in a column direction of a block stored in the GPU memory 134. The GPU memory 134 has excellent accessibility for a dataset in a specific direction but tends to have low accessibility for a dataset in a different direction. Accordingly, for fast operation of the secondary 1D FFT, matrix transposition may be operated for a primary 1D FFT-processed block.

Next, the central processing unit 120 may transmit a matrix transposition-operated block to the graphic processing unit 130.

Next, the graphic processing unit 130 may perform secondary 1D FFT processing for the matrix transposition-operated block (S125).

The secondary 1D FFT processing is performed in a second direction, where a column direction of a shift-transposed block is transformed to a row direction by a matrix transposition operation, and may be implemented by using Equation 4.

Next, the graphic processing unit 130 may transmit the secondary 1D FFT-processed block to the central processing unit 120, and the central processing unit 120 may execute an FFT shift for the block (S130) so that a next block may be prepared for the processing of steps S110 to S125.

In the processing according to the steps S110 to S130, a plurality of blocks is generated, and the central processing unit 120 may include a plurality of threads 124 and allocate the threads 124 to each block. Thus, as shown in FIG. 6, a plurality of blocks may be processed in parallel according to the steps S110 to S130 by being distributed to each thread. FIG. 6 is a view exemplifying parallel processing of a plurality of blocks using multiple threads and multiple streams. In FIG. 6, the horizontal direction is time, the vertical direction is the number of threads 124, and the arrows in the diagonal direction are streams of cores 132a to 132d.

Referring to FIG. 6, during transmission processing of the central processing unit 120 or the graphic processing unit 130 after the processing of the steps S110 to S130, at least one of the processings of another block at the steps S110 to S130, which are performed in a thread different from a thread of a block, may be performed as a parallel processing. In addition, as a plurality of blocks processed at steps S110 to S130 are processed by being allocated to a corresponding thread, the central processing unit 120 may allocate an additional thread for a stand-by block apart from the processed blocks and thus process the same shift-transposition operation and matrix transposition operation as in steps S110 and S120.

For parallel processing, the transmission processing of the central processing unit 120 or the graphic processing unit 130 may be performed asynchronously with the processings of steps S110 to S130 that are performed for another block. If asynchronous processing is described using FIG. 6 as an example, the first thread does not await to transmit the block (Chunk 1) to the central processing unit 120 until the block (Chunk 2) is completely transmitted but may complete 1D-FFT processing of the block (Chunk 1), irrespective of the transmission of the block (Chunk 2), and transmit the block (Chunk 1) to the central processing unit 120 asynchronously with the transmission of the block (Chunk 2) when a block (Chunk 1) performed in stream 1 corresponding to a first thread is completely 1D-FFT processed by the graphic processing unit 130 but a block (Chunk 2) in stream 2 corresponding to a second thread is being transmitted to the graphic processing unit 130.

In addition, the graphic processing unit 130 may have a plurality of streams in the GPU cores 132a to 132d, and primary and secondary 1D FFT processings may be performed in a stream corresponding to an allocated thread. Herein, in order to perform the transmission processing of the central processing unit 120 or the graphic processing unit 130 asynchronously with at least one of the processings at steps S110 to S130, the transmission processing may copy the block in a pinned memory buffer allocated to each of the streams and transmit it to the graphic processing unit 130 or the central processing unit 120. The pinned memory buffer may be provided to at least one of the memory 140, the CPU memory 126 and the GPU memory 134.

Apart from the asynchronous transmission using a pinned memory buffer, it is possible to consider an asynchronous transmission method that sets a memory area for keeping a target block as a pinned memory, completes processing for the block and then releases the memory area. In short, this method dynamically manages a pinned memory area.

However, the overhead for setting/releasing a pinned memory is larger than the overhead for copying a block into a pinned memory buffer. Accordingly, the pinned memory buffer approach may enhance the performance of 2D-Shift-FFT up to 20% as compared with the dynamical pinned memory method.

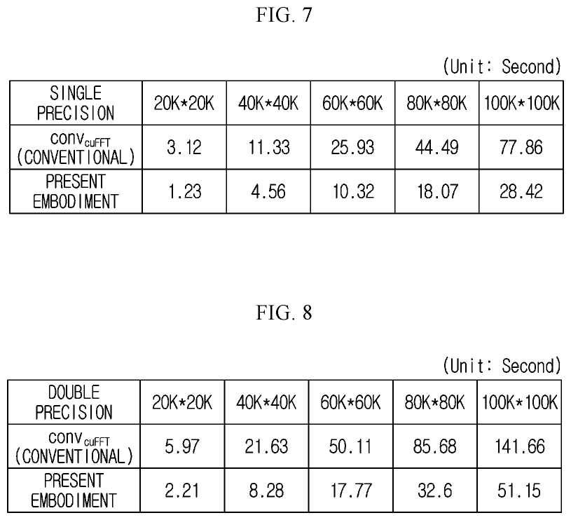

FIG. 7 and FIG. 8 are tables for comparing operation processing times between a fast Fourier operation method according to the present disclosure and a conventional fast Fourier operation method.

An experiment according to FIG. 7 and FIG. 8 used resources like two Intel Xeon CPUs (8 cores, 2.10 Ghz), a 384 GB memory, the operating system Windows 10 Pro 64 bits, and the graphic cards NVIDIA GeForce TITAN RTX 24 GB, PCIe 3.0x16, CUDA Version 10.2, and Visual Studio 2019.

As for the experimental method, Shift-2D-FFT performance is measured, and a randomly formed matrix is used to check whether or not a result value is appropriate. A same matrix is operated five times using the existing Shift-2D-FFT algorithm and the device of the present disclosure, and an average time of performing the operation is measured. conv_{cuFFT} is an algorithm of performing a column-wise 1D-FFT without matrix transposition. The 1D-FFT is performed using cuFFT (CUDA Fast Fourier Transform). cuFFT is a GPU-based FFT library manufactured by Nvidia. cuFFT is an FFT operation using a same type of equipment, but present embodiment is distinctive since it utilizes different types of equipment.

This experiment uses a double-precision matrix and a single-precision matrix, and a matrix of image data has sizes of 20K*20K, 40K*40K, 60K*60K, 80K*80K and 100K*100K. K means 10³. As for the experimental result, the present embodiment shows faster performance up to 2.52 times and 2.39 times on average, as compared to that of the existing Shift-2D-FFT.

The present embodiment shows that, since the existing Shift-2D-FFT operation performs a column-wise FFT or matrix transposition, there are problems of lowering efficiency of FFT operation and separate operation of Shift-FFT. Furthermore, there is another problem that the processing rate drastically decreases for data bigger than the GPU memory 134. However, as the present invention performs matrix transposition and FFT-Shift simultaneously, an additional operation of FFT-Shift is skipped, and data communication between GPU and CPU and matrix transposition are also performed simultaneously, so that an overall operation time can be significantly reduced.

That is, an embodiment according to the present disclosure performs Shift-2D-FFT, and since FFT-shift and 2D-FFT are performed simultaneously unlike the existing separate operation of FFT-shift and 2D-FFT, the performance may be enhanced. In order to reduce overhead occurring during data transmission of CPU and GPU, different operations are simultaneously performed during data transmission, so that the present embodiment may operation Shift-2D-FFT faster than an existing method.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for operating a fast Fourier transform for hologram generation, the method comprising:
performing, by a first processor of an image processing device, shift-transposition that executes, for image data arranged in a matrix form, a shift operation and a matrix transposition operation for a position change simultaneously;
performing, by a second processor that has faster operation performance than the first processor and processes an image, primary 1D FFT for the shift-transposed image data;
performing, by the first processor, a matrix transposition operation for the primary 1D FFT-processed image data; and
performing, by the second processor, secondary 1D FFT for the matrix transposition-operated image data.

2. The method of claim 1, wherein the image data is data of a block that is set in a predetermined data amount by considering resource performance of the second processor.

3. The method of claim 2, further comprising setting, by the first processor, the data amount of the block based on overall image data with the matrix form and a memory size of the second processor before the performing of the shift-transposition.

4. The method of claim 3, wherein the setting of the data amount of the block determines the data amount based on a number of streams used by the second processor and a data size of a line transmitted to the second processor together with the memory size of the second processor.

5. The method of claim 2, wherein the block is generated in a multiple number and the first processor includes a plurality of threads and allocates the threads to each of the block, and
the performing of the shift-transposition and the performing of the matrix transposition operation are implemented in a thread allocated to each block.

6. The method of claim 5, further comprising:
transmitting the shift-transposed block to the second processor, after the performing of the shift-transposition;
transmitting the primary 1D FFT-processed block to the first processor, after the performing of the primary 1D FFT; and
transmitting the matrix transposition-operated block to the second processor, after the performing of the matrix transposition operation,
wherein at least one of processes associated with the shift-transposition for another block, the primary and secondary 1D FTTs for another block, the matrix transposition operation for another block, and transmission for another block is performed on a thread different from the thread of the block in parallel processing during the transmitting to the first processor or the second processor.

7. The method of claim 6, wherein the transmitting to the first processor or the second processor is performed asynchronously with the processes performed on the another block for the parallel processing.

8. The method of claim 7, wherein the second processor has a plurality of streams in a core,
wherein the performing of the primary and secondary 1D FTTs is performed in the streams corresponding to the allocated thread, and
the transmitting to the first processor or the second processor transmits to the first processor or the second processor by copying the block into a pinned memory buffer that is allocated to each of the streams.

9. The method of claim 1, wherein the second processor has a smaller memory size than the first processor.

10. The method of claim 1, wherein the first processor is a central processing unit (CPU), and the second processor is a graphic processing unit (GPU).

11. An image processing device for operating a fast Fourier transform for hologram generation, the device comprising:
a first processor configured to perform overall control over the image processing device; and
a second processor that has faster operation performance than the first processor and processes an image,
wherein the first processor is configured to perform shift-transposition that executes, for image data arranged in a matrix form, a shift operation and a matrix transposition operation for a position change simultaneously,
the second processor is configured to perform primary 1D FFT for the shift-transposed image data,
the first processor is configured to perform a matrix transposition operation for the primary 1D FFT-processed image data, and
the second processor is configured to perform second 1D FFT for the matrix transposition-operated image data.

12. The image processing device of claim 11, wherein the image data is data of a block that is set in a predetermined data amount by considering resource performance of the second processor.

13. The image processing device of claim 12, wherein the first processor is further configured to set the data amount of the block based on overall image data with the matrix form and a memory size of the second processor before performing the shift-transposition.

14. The image processing device of claim 13, wherein the setting of the data amount of the block determines the data amount based on a number of streams used by the second processor and a data size of a line transmitted to the second processor together with the memory size of the second processor.

15. The image processing device of claim 12, wherein the block is generated in a multiple number and the first processor includes a plurality of threads and allocates the threads to each of the block, and
the performing of the shift-transposition and the performing of the matrix transposition operation are implemented in a thread allocated to each block.

16. The image processing device of claim 15, wherein the first processor is further configured to transmit the shift-transposed block to the second processor,
the second processor is further configured to transmit the primary 1D FFT-processed block to the first processor, and
the first processor is further configured to transmit the matrix transposition-operated block to the second processor,
wherein at least one of processes associated with the shift-transposition for another block, the primary and secondary 1D FTTs for another block, the matrix transposition operation for another block, and transmission for another block is performed on a thread different from the thread of the block in parallel processing during the transmitting to the first processor or the second processor.

17. The image processing device of claim 16, wherein the transmitting to the first processor or the second processor is performed for the parallel processing asynchronously with at least one of at least one of processes associated with the shift-transposition for another block, the primary and secondary 1D FTTs for another block, the matrix transposition operation for another block, and transmission for another block.

18. The image processing device of claim 17, wherein the second processor is further configured to have a plurality of streams in a core,
wherein the primary and secondary 1D FTTs are performed in the streams corresponding to the allocated thread, and
the transmitting to the first processor or the second processor transmits to the first processor or the second processor by copying the block into a pinned memory buffer that is allocated to each of the streams.

19. The image processing device of claim 11, wherein the second processor is further configured to have a smaller memory size than the first processor.

20. The image processing device of claim 11, wherein the first processor is a central processing unit (CPU), and the second processor is a graphic processing unit (GPU).
